(19) United States
(12) Patent Application Publication
(10) Pub. No.: US 2019/0041497 A1
(43) Pub. Date: Feb. 7, 2019

(54) CONTROLLER USING MAP ATTRIBUTES TO QUALIFY RADAR RETURNS

(71) Applicant: GM Global Technology Operations LLC, Detroit, MI (US)

(72) Inventor: Brittany M. Smith, Livonia, MI (US)

(21) Appl. No.: 15/666,999

(22) Filed: Aug. 2, 2017

(51) Int. Cl. G01S 7/41; G01S 13/93

(52) U.S. Cl. CPC G01S 7/412; G01S 2013/9346; G01S 2013/9342; G01S 13/931

(57) ABSTRACT

A system and method to qualify radar returns in a vehicle includes detecting an object using a radar system of the vehicle, and determining that the object is a never-before-seen-moving object that is stationary for an entire duration of the detecting. The method also includes determining whether the never-before-seen-moving object is indicated as a map attribute, and adjusting a confidence level of the detecting by the radar system based on determining that the object is the map attribute. An action is modified based on adjusting the confidence level.

### INTRODUCTION

The subject disclosure relates to a controller using map attributes to qualify radar returns.

Sensor systems are increasingly used in vehicles (e.g., automobiles, farm equipment, construction equipment, automated factory equipment) to augment or automate operation. For example, some vehicles include an automatic braking system in order to avoid collision with an object. These types of systems rely on sensor systems to detect the objects that give rise to driver warnings or automated actions. One such sensor system is a radar system. A radar system transmits radio waves and processes reflected signals to determine the range, angle, and velocity of the objects that reflected the signals. When the radar detects an object that does not move during the entire duration of the detection, the object may be a stationary object that cannot move or the object may only be stationary during the detection period. The distinction between the two cases cannot be made with the radar system alone, which can complicate the operation of vehicle systems that use the radar information. Accordingly, it is desirable to provide a way to qualify radar returns.

### SUMMARY

In one exemplary embodiment, a method of qualifying radar returns in a vehicle includes detecting an object using a radar system of the vehicle, and determining that the object is a never-before-seen-moving object that is stationary for an entire duration of the detecting. The method also includes determining whether the never-before-seen-moving object is indicated as a map attribute, and adjusting a confidence level of the detecting by the radar system based on determining that the object is the map attribute. An action is modified based on the adjusting the confidence level.

In addition to one or more of the features described herein, the detecting the object for the entire duration includes detecting the object for a duration that the object is in a field of view of the radar system as the vehicle approaches the object.

In addition to one or more of the features described herein, the determining whether the never-before-seen-moving object is indicated as the map attribute includes obtaining map attributes.

In addition to one or more of the features described herein, the obtaining the map attributes includes obtaining locations of the map attributes within a field of view of the radar system.

In addition to one or more of the features described herein, the obtaining the map attributes includes obtaining the locations of manhole covers and storm drains.

In addition to one or more of the features described herein, the adjusting the confidence level includes adjusting the confidence level differently based on a type of the map attribute that the object is determined to be.

In addition to one or more of the features described herein, the adjusting the confidence level is different when the map attribute is a manhole cover or a storm drain.

In addition to one or more of the features described herein, the modifying the action includes overriding a driver warning.

In addition to one or more of the features described herein, the modifying the action includes overriding an automatic braking action or overriding delayed braking.

In addition to one or more of the features described herein, the modifying the action includes overriding an automatic steering action.

In another exemplary embodiment, a system to qualify radar returns in a vehicle includes a radar system of the vehicle to detect an object in a field of view of the radar system. The system also includes a controller to determine that the object is a never-before-seen-moving object that is stationary for an entire duration of detection by the radar system, determine whether the never-before-seen-moving object is indicated as a map attribute, adjust a confidence level of the detection by the radar system based on determining that the object is the map attribute, and modify an action based on adjustment of the confidence level.

In addition to one or more of the features described herein, the entire duration of the detection includes a duration that the object is in the field of view of the radar system while the vehicle approaches the object.

In addition to one or more of the features described herein, a mapping application provides map attributes to the controller. The controller determines whether the never-before-seen-moving object is indicated as the map attribute among the map attributes from the mapping application of the vehicle.

In addition to one or more of the features described herein, the controller obtains locations of the map attributes within the field of view of the radar system.

In addition to one or more of the features described herein, the map attributes include manhole covers and storm drains.

In addition to one or more of the features described herein, the controller adjusts the confidence level differently based on a type of the map attribute that the object is determined to be.

In addition to one or more of the features described herein, the controller adjusts the confidence level differently when the map attribute is a manhole cover or a storm drain.

In addition to one or more of the features described herein, the controller modifies the action by overriding a driver warning.

In addition to one or more of the features described herein, the controller modifies the action by overriding an automatic braking action or overriding a delayed braking action.

In addition to one or more of the features described herein, the controller modifies the action by overriding an automatic steering action.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a block diagram of a system to qualify radar returns according to one or more embodiments; and

FIG. 2 is a process flow of a method of qualifying radar returns in a vehicle according to one or more embodiments.

### DETAILED DESCRIPTION

The following description is merely exemplary in nature and is not intended to limit the present disclosure, its application or uses.

As previously noted, a radar system alone cannot determine if a detected object that has not moved during the duration of the detection (referred to as a never-before-seen-moving object) is truly stationary (e.g., building, sign) or temporarily stationary (e.g., car stopped at a stop sign). As such, when a never-before-seen-moving object is detected by a radar system, vehicle systems (e.g., automatic braking system, automated driving system, collision avoidance system) cannot rely on the radar data in determining the proper action to be taken. Data fusion or the comparison of information gathered by different sensors (e.g., radar system, camera) has previously been used as a way to qualify the information obtained with each sensor alone. However, this approach increases the complexity of the processing and is not a straight-forward approach to qualifying one of the sensors.

Embodiments of the systems and methods detailed herein relate to using map attributes to qualify radar returns. Specifically, a controller uses a mapping application to qualify the radar returns. The mapping application may be part of the navigation system of the vehicle or may use a standard definition (SD) or high definition (HD) map rendered based on a light detection and ranging (lidar) or other sensor data. While the navigation system may provide directions, the SD or HD map may only provide a reconstruction of the road configuration within the vicinity of the vehicle. According to one or more embodiments, the mapping application is used in conjunction with map attributes. When the mapping application is part of the vehicle navigation system, for example, map attributes may be provided by the navigation system, as well. When the mapping application uses a map, map attributes may be obtained from a different database and overlaid on the map. The map attributes indicate objects that may have radar signatures, such as manhole covers, signs, storm drains, and other fixed objects. A controller, according to the embodiments detailed herein, uses the map attributes to qualify radar returns such that actions taken by vehicle systems based on the radar information may be modified or augmented.

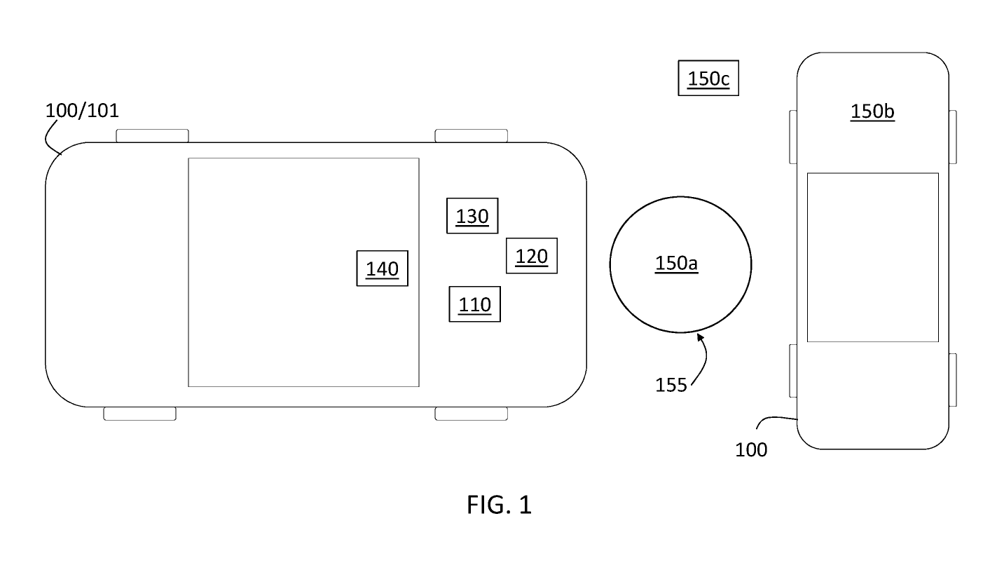

In accordance with an exemplary embodiment, FIG. 1 is a block diagram of a system to qualify radar returns. The exemplary vehicle 100 shown in FIG. 1 is an automobile 101. The automobile 101 includes a controller 110, radar system 120, vehicle systems 130, and mapping application 140 (e.g., navigation system, HD map, SD map). The controller 110 includes processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The radar system 120 may be a multi-input multi-output (MIMO) radar commonly used in vehicle 100 applications, for example. The radar system 120 detects range and velocity of objects in its field of view. The vehicle systems 130 may control one or more aspects of vehicle 100 operation (e.g., steering, braking, deceleration) and may alternately or additionally provide information to the driver (e.g., infotainment system). The controller 110 may be part of the radar system 120, may be part of one or more vehicle systems 130, or may be in communication with the radar system 120 or vehicle systems 130 according to the arrangement shown in FIG. 1.

Three exemplary radar targets 150a, 150b, 150c (generally referred to as 150) are shown in FIG. 1. Target 150a is a manhole cover that does not move, target 150b is another vehicle 100 that may be stationary for at least part of the duration of the detection by the radar system 120. Target 150c is not in the path of the automobile 101 and may be a stationary lamp post, for example. Each of these three targets 150 is tracked by the radar system 120 as the automobile 101 approaches the position shown in FIG. 1. As the target 150b, the other vehicle 100 indicates, the fact that a target 150 is a never-before-seen-moving object alone cannot be a reason to disqualify the object as a potential hazard. Thus, simply filtering out targets 150 that are never-before-seen-moving objects from consideration by vehicle systems 130 that take action to avoid or warn against potential collisions is an ineffective approach. The target 150b may be a stalled or stopped vehicle 100 that must be avoided, for example.

Based solely on the radar system 120, both the target 150a (the manhole cover) and the target 150b (another vehicle 100) may result in some form of intervention. The driver may be provided with a warning through one of the vehicle systems 130, or automatic braking or steering may be initiated through other vehicle systems 130. Yet, the target 150a, the manhole cover, does not require any driver warning or automated action. The automobile 101 can simply drive over the manhole cover.

According to one or more embodiments, the controller 110 consults the mapping application 140 that includes map attributes 155 and determines if a target 150 that is a never-before-seen-moving object matches a map attribute 155 at the same location. In the exemplary scenario shown in FIG. 1, the manhole cover (target 150a) is a map attribute 155. As previously noted, map attributes are known features (e.g., manhole covers, storm drains) that are included in information provided by the mapping application 140. Thus, in the exemplary scenario shown in FIG. 1, if the target 150a and the target 150b are both never-before-seen-moving objects, the controller 110 would determine, based on information from the mapping application 140, that the target 150a is a map attribute 155 that is a manhole cover that can be driven over but the target 150b is not a map attribute. As such, the map attribute 155 information qualifies the radar return.

This qualifying information may be used by the controller 110 to modify actions taken by one or more vehicle systems 130. For example, braking by the braking vehicle system 130 may be delayed based on a determination that the target 150a is a manhole cover, as indicated by the map attribute 155, but the target 150b, which is farther away, is an object with which collision should be avoided. Further, if the target 150b were not present at all (i.e., only the target 150a were detected in the path of the vehicle 100), then action by a vehicle system 130 to warn the driver or take action (e.g., brake, steer) may be overridden altogether by the controller 110 as being unnecessary. An override may be accomplished according to more than one embodiment. According to an exemplary embodiment, the vehicle system 130 may output the warning, for example, but the warning may be cancelled, based on the override by the controller 110, prior to being displayed to the driver. According to an alternate embodiment, the vehicle system 130 may be provided with the override by the controller 110 such that the generation of the warning is suppressed.

The qualifying information provided by the map attributes 155 may be used to increase confidence in the radar system 120 output, as well. That is, the example discussed with reference to the target 150a, the manhole cover, is one in which the confidence level of the radar system 120 output is reduced (i.e., the target 150a identified by the radar system 120 is determined not to be a hazard). As a result, the controller 110 overrides action that may otherwise be taken. However, when the controller 110 determines that a target 150 identified by the radar system 120 does not match a map attribute 155, the confidence in the output of the radar system 120 may be increased. This increased confidence, like the decreased confidence in the other scenario, may result in an override of an action by a vehicle system 130. For example, a delay in automatic braking may be implemented by the adaptive cruise control vehicle system 130 based on a false alarm rate or other condition. This delay may be overridden by the controller 110 based on determining that a target 150 detected by the radar system 120 does not match a map attribute 155.

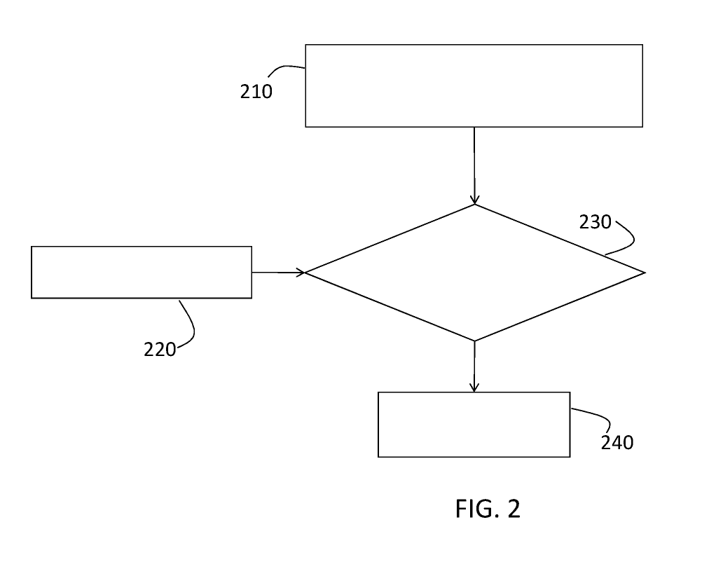

FIG. 2 is a process flow of a method of qualifying radar returns in a vehicle 100 according to one or more embodiments. At block 210, obtaining object tracking information includes obtaining the data from the radar system 120 that includes target 150 detection and tracking information. As previously noted, the radar system 120 estimates the range and velocity of each detected target 150. Thus, the location of each target 150 may be estimated. At block 220, obtaining map attributes 155 may be done continuously along with the radar system 120 information according to an exemplary embodiment. That is, as the vehicle 100 moves, the map attributes 155 within a specified distance (e.g., a distance corresponding with the maximum range of the radar) may always be obtained. As previously noted, the map attributes 155 may be part of the mapping application 140 (e.g., navigation system) or may be overlaid with the mapping application (e.g., HD map). In alternate embodiments, obtaining map attributes 155, at block 220, may only be done by the controller 110 when the radar system 120 has detected a never-before-seen-moving target 150.

At block 230, a check is done of whether a target 150 detected by the radar system 120 is in a location of a map attribute 155 as indicated by the mapping application 140. This check may be done only for never-before-seen-moving targets 150 according to an exemplary embodiment. At block 240, qualifying a radar return includes determining if a detected target 150 is in the same location as a map attribute 155. Based on the controller 110 determining that a target 150 is or is not a map attribute 155, qualifying the radar return, at block 240, includes adjusting a confidence level associated with the radar return. As previously noted, the confidence level may be decreased if the target 150 is determined to be a map attribute 155 by the controller 110, and the confidence level may be increased if the target 150 is determined not to be a map attribute 155 by the controller 110. The confidence level refers to the confidence that the target 150 detected by the radar system 120 is necessarily an object that could collide with or otherwise impede the vehicle 100.

The particular map attribute 155 determines the adjustment or degree of adjustment in confidence level. For example, if the target 150 is determined to be a storm drain rather than a manhole cover, then the map attribute 155 indicating a storm drain does not adjust the confidence level as much as a map attribute 155 indicating a manhole cover would. This is because a manhole cover may simply be driven over by the vehicle 100 while the storm drain is an object that must still be avoided by the vehicle 100, although it need not be tracked like a moving object (e.g., another vehicle 100, pedestrian). Qualifying the radar return, at block 240, may include modifying or overriding one or more actions initiated by the radar return. As discussed with reference to FIG. 1, for example, the determination that a target 150 (e.g., target 150a) is a map attribute 155 (e.g., manhole cover) may lead the controller 110 to prevent a warning message from being issued to the driver or delay automated actions such as braking or steering away from the target 150.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of qualifying radar returns in a vehicle, the method comprising:
detecting an object using a radar system of the vehicle;
determining that the object is a never-before-seen-moving object that is stationary for an entire duration of the detecting;
determining whether the never-before-seen-moving object is indicated as a map attribute;
adjusting a confidence level of the detecting by the radar system based on determining that the object is the map attribute; and
modifying an action based on the adjusting the confidence level.

2. The method according to claim 1, wherein the detecting the object for the entire duration includes detecting the object for a duration that the object is in a field of view of the radar system as the vehicle approaches the object.

3. The method according to claim 1, wherein the determining whether the never-before-seen-moving object is indicated as the map attribute includes obtaining map attributes.

4. The method according to claim 3, wherein the obtaining the map attributes includes obtaining locations of the map attributes within a field of view of the radar system.

5. The method according to claim 4, wherein the obtaining the map attributes includes obtaining the locations of manhole covers and storm drains.

6. The method according to claim 1, wherein the adjusting the confidence level includes adjusting the confidence level differently based on a type of the map attribute that the object is determined to be.

7. The method according to claim 6, wherein the adjusting the confidence level is different when the map attribute is a manhole cover or a storm drain.

8. The method according to claim 1, wherein the modifying the action includes overriding a driver warning.

9. The method according to claim 1, wherein the modifying the action includes overriding an automatic braking action or overriding delayed braking.

10. The method according to claim 1, wherein the modifying the action includes overriding an automatic steering action.

11. A system to qualify radar returns in a vehicle, the system comprising:
a radar system of the vehicle configured to detect an object in a field of view of the radar system; and
a controller configured to determine that the object is a never-before-seen-moving object that is stationary for an entire duration of detection by the radar system, determine whether the never-before-seen-moving object is indicated as a map attribute, adjust a confidence level of the detection by the radar system based on determining that the object is the map attribute, and modify an action based on adjustment of the confidence level.

12. The system according to claim 11, wherein the entire duration of the detection includes a duration that the object is in the field of view of the radar system while the vehicle approaches the object.

13. The system according to claim 11, further comprising a mapping application configured to provide map attributes to the controller, wherein the controller is configured to determine whether the never-before-seen-moving object is indicated as the map attribute among the map attributes from the mapping application of the vehicle.

14. The system according to claim 13, wherein the controller is further configured to obtain locations of the map attributes within the field of view of the radar system.

15. The system according to claim 13, wherein the map attributes include manhole covers and storm drains.

16. The system according to claim 11, wherein the controller is configured to adjust the confidence level differently based on a type of the map attribute that the object is determined to be.

17. The system according to claim 16, wherein the controller is configured to adjust the confidence level differently when the map attribute is a manhole cover or a storm drain.

18. The system according to claim 11, wherein the controller is configured to modify the action by overriding a driver warning.

19. The system according to claim 11, wherein the controller is configured to modify the action by overriding an automatic braking action or overriding a delayed braking action.

20. The system according to claim 11, wherein the controller is configured to modify the action by overriding an automatic steering actio
